(19) United States
(12) Patent Application Publication
(10) Pub. No.: US 2010/0023459 A1
(43) Pub. Date: Jan. 28, 2010

(54) METHOD AND APPARATUS FOR FINANCIAL TRANSACTIONS

(76) Inventor: Dale Sundby, La Jolla, CA (US)

Correspondence Address: GAZDZINSKI & ASSOCIATES, 11440 WEST BERNARDO COURT, SUITE 375, SAN DIEGO, CA, 92127, US

(21) Appl. No.: 12/502,148

(22) Filed: Jul. 13, 2009

Related U.S. Application Data
(60) Provisional application No. 61/134,928, filed on Jul. 14, 2008.
(60) Provisional application No. 61/181,241, filed on May 26, 2009.

(51) Int. Cl. G06Q 40/00

(52) U.S. Cl. 705/36 R

(57) ABSTRACT

Method for measuring performance in securities trading is disclosed; the method comprises associating trades with a user profile and examining performance and updating the profile based in part on the trades. Trading may be simulated or may comprise actual trading of securities through one or more broker partners. Social networking options and features are also provided. A method of providing a synchronized securities trading is also given, the method comprising servicing trades of a first entity (the first entity may be an individual or an RIA) and servicing a similar trade by a second entity. According to this method payment to the first entity is calculated as a percentage of the amount traded by the second entity or by examining performance of trades with respect to a reference. The reference may comprise for example the S&P 500 or Dow Jones Industrial Average. Methods of conducting business are also given.

### PRIORITY

This application claims priority to U.S. Provisional Patent Application Ser. No. 61/134,928, filed on Jul. 14, 2008 and entitled “METHOD AND APPARATUS FOR FINANCIAL TRANSACTIONS” and U.S. Provisional Patent Application Ser. No. 61/181,241, filed on May 26, 2009 and entitled “METHOD AND APPARATUS FOR FINANCIAL TRANSACTIONS”, each of which is incorporated herein by reference in its entirety.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. FIELD OF THE INVENTION

The present invention relates to improved methods and apparatus for trading, managing, and analyzing securities and other financial instruments.

### 2. DESCRIPTION OF RELATED TECHNOLOGY

A large variety of approaches to financial instrument trading, tracking, and analysis are available to an individual investor. Many of these approaches are geared toward automated trading or execution of orders, while others are more analytically focused; i.e., adapted to provide the user with information with which they can make decisions.

Alternatively, a small or personal investor may utilize on-line (i.e., Internet-based) financial instrument trading and monitoring systems. For example, many standard Internet search engines such as Yahoo! include a “financial markets” or similar link/tab which routes the user to a customizable web (e.g., html) page. This web page allows the user to structure equity quotes data, in effect providing near-real-time updates (typically delayed from the market by some increment of time). However, these approaches suffer from several disabilities including, inter alia: (i) they are not truly “real time”, (ii) they do not offer users the opportunity to trade directly and/or utilize proven investment strategists; (iii) they provide little if any analytical capabilities; and (iv) a user is not assisted by professionals in making their investment selections.

Similarly, so-called “streamer” programs and services such as those offered by TD Ameritrade stream “real-time” data to users over a network; e.g., Internet connection. The Ameritrade streamer provides bid, ask, strike, share volume, etc. data is a generally tabular form, with audible alerts and visual cues (e.g., glowing green or red highlights for increasing or decreasing data, respectively). Aside from recent price/trend graphs and the like, however, the TD Ameritrade and similar streamed solutions offer no real opportunity for a user to interface with a professional and/or utilize registered investment advisors in making investment decisions.

### Registered Investment Advisors

Registered Investment Advisors (RIA's) have a fiduciary duty to put their clients' interests ahead of their own, thus, RIAs occupy a special position among the 300,000 professional financial advisors in the U.S. (which include full-service brokers, independent financial planners, bank and savings institution representatives, insurance agents, and accountants). Absent the RIA legal duty and governmental oversight, investors simply cannot know their advisors' motivation. They are much more likely to be taken advantage of by sales tactics designed to produce the most income for the advisor, not the investor.

About 90% of the 90 million US citizens who own equities (e.g., shares of stock, mutual funds, etc.) fall into the category of “middle” or “mass market”. These investors are not wealthy, and generally their trades are not serviced by the 40,000 RIAs registered in the US. Rather, only the top wealth tiers of investors can afford RIA services. The individual investors are thus caught with making difficult investment decisions (including the choice of buying or selling certain stocks or mutual funds) without RIA assistance.

Additionally, existing commission or “load” structures are generally flat or predetermined, such as a percentage of the assets invested by the individual investor, and do not consider performance. Even so-called “no load” mutual funds carry an intrinsic or hidden load (cost), and this is generally tied to the assets invested (e.g., a flat percentage) or some similar criterion which does not consider the performance of the equities or fund as a whole. Interestingly, the majority of mutual funds tend to underperform common indices such as the S&P 500, and yet still charge explicit or implicit load. Stated differently, had an investor simply bought the same equities as those comprising the S&P 500, they would have outperformed most mutual funds, and without a load.

Accordingly, despite the wide variety of financial and networking approaches described by the foregoing prior art techniques, there is a salient need for an improved apparatus and methodology of financial securities trading. Such improved apparatus and methodology would ideally allow users (including most particularly the aforementioned 90% of the investing user base) to evaluate market dynamics in real time, and act according to the experience of one or more proven investors whether RIAs or others. Exemplary apparatus and methods would also enable such users to test one or more market strategies.

Furthermore, exemplary approaches would also provide these users with the ability to create descriptive profiles for social and investment networking, and view profiles of other investors (including non-RIA investors having a high level of performance, as well as RIA investors or fund managers).

It would also be desirable to have a solution which couples find or equity performance over time with the load or commission charged, thereby inter alia providing strong incentive for fund managers or RIAs to outperform their contemporaries (i.e., “no performance, no pay”).

### SUMMARY OF THE INVENTION

In a first aspect of the invention, a method for measuring performance in the trading of securities trading is disclosed. In one embodiment, the method comprises: creating a user profile; selecting or entering one or mote trading options; taking actions to trade securities; associating said actions taken to trade securities with said user profile; examining performance based at least in part on said actions taken to trade securities; and updating said user profile consistent with said act of examining. In one variant, the method comprises trading options for simulated trades. In another variant, said user profile comprises a social network profile and individual ones of said users communicate with one another via said profile.

In a second aspect of the invention, a method of providing a user synchronized trading of securities is given. In one embodiment the method comprises: providing a list of trading entities and information relating to the performance thereof; selecting at least one of said plurality of trading entities from said list; servicing at least one trade of securities by said trading entity; servicing at least one similar trade of securities by said user; examining the performance of said trading entity based at least in part on said serviced at least one trade of securities by said trading entity; and calculating payment to said at least one trading entity based at least in part on said examined performance. In one variant payment is calculated based on comparison of said performance against a reference. The reference may comprise the S&P 500, Dow Jones Industrial Average, or other relevant market index. In another variant, the act of selecting is accomplished by a computer program adapted to make said selection based at least in part on information regarding said user's investment goals, risk tolerance, and tax bracket.

In a third aspect of the invention, a system for providing securities trading information and synchronized trading opportunities is given. In one embodiment the system comprises: at least one trading server, at least one user device; and at least one broker partner server, said at least one trading server, said at least one user device, and said at least one broker server adapted to communicate with one another via the Internet.

In a fourth aspect of the invention, a method of providing securities trading information and synchronized trading opportunities is given. In one embodiment, the method comprises: providing a database of a plurality of trading entities; providing at least one engine configured to examine the performance of said plurality of trading entities; providing a database of a plurality of users; creating a matrix linking at least one of said plurality of users to at least one of said plurality of trading entities; causing said linked at least one of said plurality of users to trade identical securities simultaneous with trading securities of said at least one of said plurality of trading entities.

In a fifth aspect of the invention a method of providing updated information regarding the profitability of one or more trading entities is given. In one embodiment the method comprises: said one or more trading entities each creating a profile; said one or more trading entities trading securities; reporting said trades to a computer program adapted to: compare said trades to stock information over a predetermined period of time, determine whether the net effect of said trades, update said user profile in accordance with said determination of the net effect of said trades, and compare said one or more trading entities updated profiles to one another to develop a list of said one or more trading entities. In one variant the method may be utilized to compare one or more of a subset of users as a class.

In a sixth aspect of the invention a method of conducting business is given. In one embodiment the method comprises providing one or more investment data generating and synchronized securities trading functions; inserting said one or more functions into an existing web page.

In another embodiment, the method comprises: providing advertising opportunities within a web-based module for delivering investment data and synchronized securities trading options.

In a seventh aspect of the invention, an improved electronic management and communication architecture is disclosed which may be used in conjunction with the foregoing method and financial arrangement architecture. The electronic architecture generally comprises a server device operatively connected to one or more homogeneous or heterogeneous client devices via a communications network, the server device and client devices having software running on each respectively which facilitates secure communication between the server and client device(s). In one exemplary embodiment, the electronic architecture comprises a secure server device having a distributed server software portion and associated database, the server being operatively connected to one or more client devices via an untrusted network such as the Internet, the client devices each having a client software portion adapted to interface with the server portion. A user may enter data into the server device's database through the client device after proper authentication, utilizing the Internet to convey this information. The user can obtain investment information (such as performance data of stocks and bonds, performance of the user's portfolio, performance of other user's portfolios, etc.) and communicate with other investors (via, instant messaging, e-mail, web blogs, or chat rooms).

### BRIEF DESCRIPTION OF THE DRAWINGS

FIG. 1a is a graphical illustration of a display image of an exemplary profile interface according to the present invention.

FIG. 1b is a graphical illustration of a display image of an exemplary market interface according to the present invention.

FIG. 1c is a graphical illustration of a display image of an exemplary quote interface.

FIG. 2 is a graphical illustration of a display image of an exemplary social interface according to the present invention

FIG. 2a is a graphical illustration of a display image of an exemplary network interface according to the present invention.

FIG. 2b is a graphical illustration of a display image of an exemplary group interface according to the present invention.

FIG. 2c is a graphical illustration of a display image of an exemplary comparison interface according to the present invention.

FIG. 3 is a block diagram illustrating one embodiment of a method for trading securities according to the present invention.

FIG. 4 is a block diagram illustrating exemplary network architecture useful in the present invention.

FIG. 4a is a block diagram illustrating the functioning of exemplary network architecture of the present invention.

FIG. 5 is a graphical illustration of a display image of an exemplary contest interface according to the present invention.

FIGS. 6a and 6b are graphical illustrations of display images of an exemplary iFrame inserts into exemplary lifestyle and investing websites, respectively, according to the present invention.

FIG. 7 is a block diagram illustrating an exemplary architecture for providing pooled investments.

FIG. 7a is a block diagram illustrating an exemplary investment management entity.

FIG. 8 is a logical flow diagram illustrating an exemplary method of portfolio pooling.

FIG. 8a is a logical flow diagram illustrating an exemplary method of establishing and maintaining an investment pool of companies developing climate friendly products, services, and technologies.

All Figures disclosed herein are © Copyright 2008-2009 DEEPMoney, Inc. All rights reserved.

### DETAILED DESCRIPTION OF THE INVENTION

Reference is now made to the drawings wherein like numerals refer to like parts throughout.

As used herein, the terms “client device,” “terminal,” “personal electronic device” (PED) and “user device” include, but are not limited to, personal computers (PCs), whether desktop, laptop, or otherwise, personal digital assistants (PDAs), personal communicators or media devices, J2ME equipped devices, cellular telephones, set-top boxes, or literally any other device capable of interchanging data with a network or another client device. Such devices may interface using wired or optical fiber mechanisms such as an IEEE Std. 802.3 Ethernet interface, Digital Subscriber Line (DSL), modem, DOCSIS modem, hybrid fiber-coax (HFC) cable, or alternatively via wireless mechanisms and protocols such as 3G (e.g., 3GPP, 3GPP2, UMTS), Bluetooth™, IRDA interface, IEEE Std. 802.11 (WiFi), UWB (e.g., IEEE-Std. 802.15 or similar), WiMAX (IEEE Std. 802.16), MWBA (IEEE Std. 802.20), Wireless Application Protocol (WAP), GPRS, GSM, or any other of myriad data communication systems and protocols well known to those of skill in the communications arts.

As used herein, the term “database” refers generally to one or more virtual or actual data storage locations or entities, which may or may not be physically co-located with each other or other system components.

As used herein, the term “network” refers generally to data or communications networks regardless of type, including without limitation, LANs, WANs, PANs, intranets, internets, the Internet, cable systems, satellite networks, piconets, and Virtual Private Networks (VPNs), whether utilizing wired or wireless physical interface.

As used herein, the term “service provider” refers generally to services provided remotely to the user including, for example, data streaming, data analysis, financial account management and trading, data archiving and storage, Internet access, content delivery, etc.

As used herein, the terms “trade” and “securities trade” refer to any type of financial or other transaction which involves the sale and purchase of a “security”, such “security” being intangible (such as for example shares of an equity issue, options, futures, derivatives, mutual funds, “spiders”, government securities, limited partnership interests such as RELPs, REITS, bonds, etc.) or tangible (such as for example so-called “real” property such as real estate, personal property, etc.) or commodities (e.g., gold). Literally any type of instrument whose value fluctuates as a function of time may conceivably benefit from the methods of the present invention.

### Overview

In one salient aspect, the invention provides methods and apparatus for measuring performance in securities trading, and making use of this information. In one embodiment performance is measured by associating actions taken to trade securities with a user profile, and updating the user profile consistent with these trades. Trading according to the present invention may be actual or simulated; the present invention may also provide an educational environment and/or contest environment for users.

The user profiles described herein may also be utilized in conjunction with a social network, wherein individual users are able to communicate with one another to discuss investment strategies, view portfolio and network generally based on shared interests.

Methods and apparatus for providing synchronized securities trading are also given. Synchronized trading allows a first user (or group of users) to have his/her trades substantially or identically mirror a second user's trades. In one implementation, the second user comprises a registered investment advisor (RIA) or other investment professional. In one model, a user (RIA or other) whose trades are mirrored will be compensated by the user(s) who mirror their trades, as a percentage of the mirroring trade or as a percentage of the performance in excess of one or more reference criteria, such as the performance of the S&P 500 index or Dow Jones Industrial Average (DJIA).

A “smart” index is also provided which determines, based on a user's financial goals and risk tolerance, which other user's trades to mirror.

Methods of conducting business including providing investment data, synchronizing securities trading functions into an insert within an existing web page are also described herein.

### User Interfaces

Exemplary embodiments of various user interfaces useful with the methods and apparatus of the present invention are now described in detail.

In one embodiment, the present invention provides a web-based module to be employed by one or more network users. Individual investors having any level of experience in trading securities, as well as Registered Investment Advisors (RIA), or other registered professional financial advisors or securities trading professionals (hereinafter referred to collectively as “users”) may utilize the web-based module as described below. Each of the aforementioned users is given access to inter alia, investment information, as well as social interfacing tools in order to make investment decisions via the web-based module.

In order to access the features discussed below, a user must establish a user profile. The user profile will comprise information which will be displayed to other users (such as display name, photo, icon or avatar, etc.) as well as information which is necessary for administrative purposes (such as e-mail address, first and last name, etc.). The user may also establish a username or login ID and password in order to access the profile, view personalized messages and investing information, and be linked to other users. Various interfaces are made available to a user when the user “logs into” the web-based module.

It will also be noted that a “user” may comprise more than one individual and may represent an entity. For example, a user under one embodiment comprises a trading or investment club. Alternatively, a user may also comprise an institution (e.g., brokerage, university, hospital), or a fiduciary (e.g., trustee for a trust, etc.).

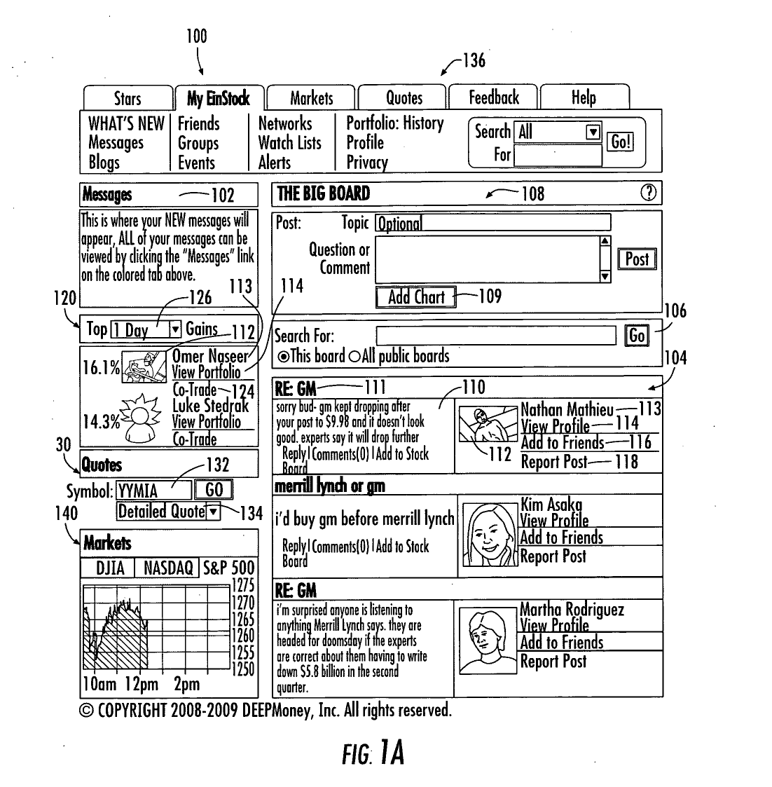

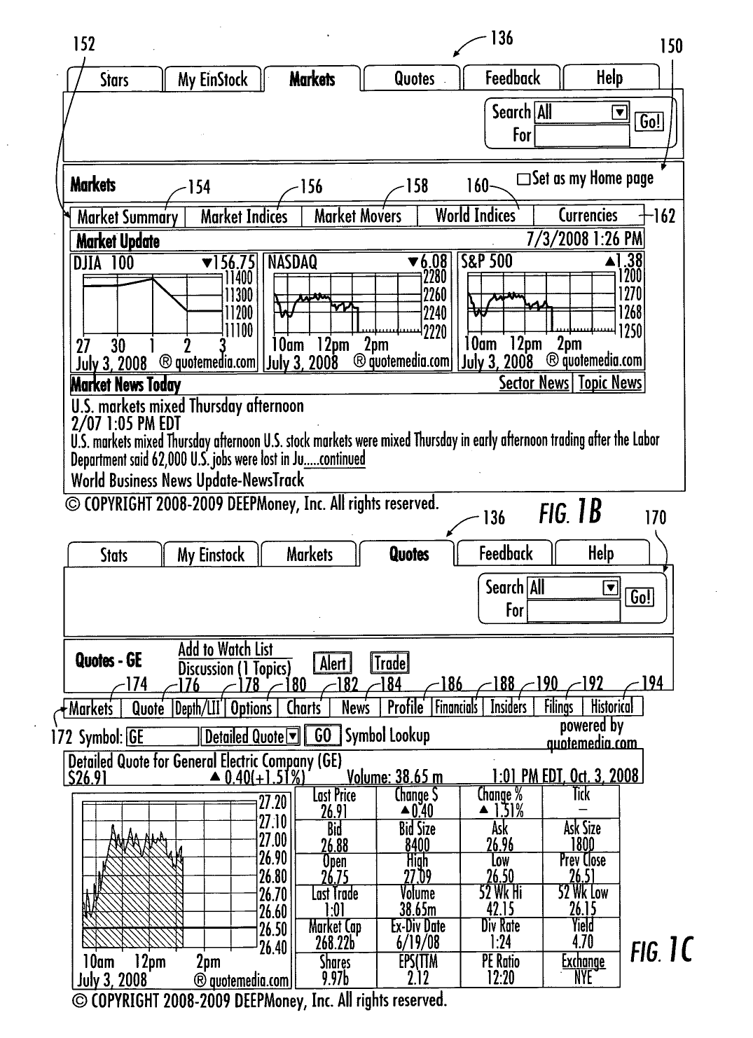

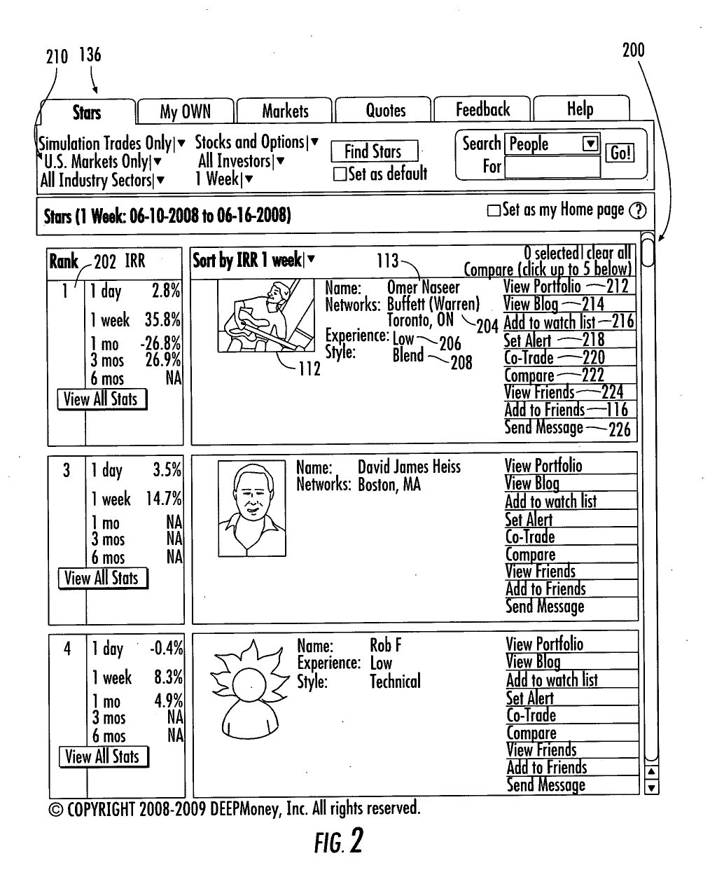

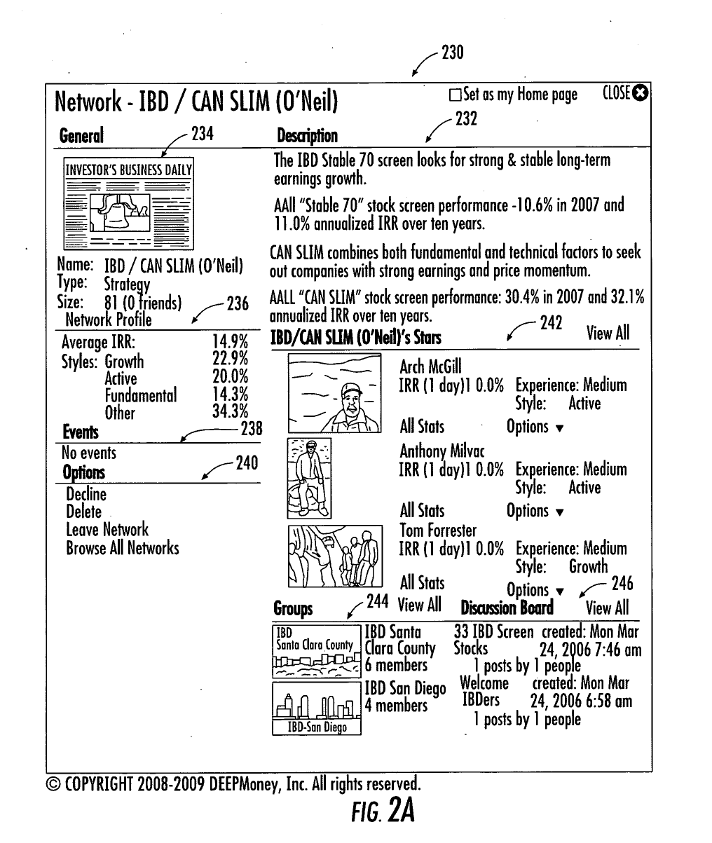

Exemplary user interfaces are illustrated in FIGS. 1a-1c. It will be appreciated however, that alternative interface layouts having the same or similar function to that described below may be utilized consistent with the present invention. Furthermore, the interfaces discussed below may be similar in format and/or function to the DEEPmoney® EinStock websites operated by the Assignee hereof. Additionally, while graphical user interfaces are illustrated, other types of user interfaces may be used, whether alone or in combination with those exemplary embodiments described herein. For example, a speech recognition engine/interface (via e.g., a microphone) may be used to receive user input or commands. The user interface may also be equipped with video telephony (via e.g., web cam), VoIP, chat, or similar mechanisms which operate over a circuit-switched or packet-switched network of the type well known in the networking and communication arts.

When a user enters the exemplary website implementing the systems and methods of the present invention, the user is taken to a profile interface which displays at least partially user-selected options and tools. However, as discussed below, a user may select to view other interfaces as well. An exemplary profile interface is given in FIG. 1a, however it is appreciated that features, options and tools other than those discussed below may be presented to the user, and in one embodiment the user may direct which features are made available at the profile interface 100 when the user sets up an account or profile or via a function to edit personal settings (not shown).

Referring again to FIG. 1a, one variant of a profile interface 100 is given. In the embodiment of FIG. 1a, the profile interface 100 displays a message inbox feature 102. At the message inbox 102 (similar to an e-mail inbox), the user may view messages left for the user by other members or administrative/network entities. It is noted that the messages may be fully displayed, partially displayed or summarized in the message inbox 102 section of the profile interface 100. It is also appreciated that RIA and other entities seeking to advertise services and/or products to the user may also leave messages for the user at the message inbox 102. By using a mouse or other UI indicator (e.g., touchpad, trackball), or using a touch screen interface on their terminal, the user can select the inbox 102, and then be taken to a message interface (not shown) which provides email creation, receipt and transmission functionality.

The exemplary profile interface 100 of FIG. 1a also displays a public message board. The public message board provides options for a user to view current public messages posted by other members by scrolling posted messages 104, to search posted messages via a searching tool 106, and to post messages via a message posting tool 108 (including posting accompanying figures, etc. via an attachment adding mechanism 109). When a user posts a message, the message body 10 is displayed among the other posted messages 104 along with its associated topic (if given) 111, and certain aspects of the posting user's profile such as, e.g., a photo 112, a name 113, a link to view the user's profile 114, a link to add the user to a friend or group list 116, and/or a link to report the user to administrative entities 118.

When viewing posted messages 104, a user has options to reply to the message, save the message to a private board, and view other comments on regarding the same message. If charts or attachments were added to a posted message 104, the user is also given a mechanism for viewing these. Each of the above-described features is self-explanatory and relies on mechanisms well known in the computer arts; hence, these will not be discussed in further detail herein.

FIG. 1a also displays an exemplary configuration of a “high gain” indicator 120. In one variant, the high gain indicator 120 calculates the percent profit gain 122 among all users, then displays portions of the portfolio of the those users having the highest percent profit gain 122 (which may be determined according to e.g., a user-prescribed threshold or value). Alternatively, the high gain-indicator 120 may only indicate highest earners of among the non-RIA users, or any other logical subset of the user population as may be specified by the user. In the illustrated embodiment, the percent profit gained 122 for each high gaining user is given alongside the user's profile photo 112, a link to view the user's profile 114, and a link to enable co-trades 124 with the user. Co-trading will be discussed in greater detail below, but generally refers to adapting similar trading strategies as the selected user (or users).

FIG. 1a also demonstrates other features which may optionally be presented to a user at the profile interface 100. As illustrated, the user may utilize a “quick quot&” tool 130, which has a box 132 for allowing the user to enter a stock ticker symbol, company name, or other descriptive information. The user may also select from a pull down menu 134 to choose from among various options for receiving various types and formats of information. For example, the user may select from the pull down menu 134 to view, inter alia, market update information, a detailed quote, real-time level 2 information, and/or option chain information, interactive and comparative charts, recent news regarding the company and/or stock, a profile of the company, financial information, and/or information regarding insider activities. The user may also view SEC filings for the company and/or stock historical information over a user-selected period of time. Selection to view any of the above information may, in one embodiment, result in the user being taken to the quote interface (discussed below) which displays the information, and gives the user an option to view other information. Note however, that options to view information other than that listed above may also be given at the quick quote tool 130.

At the profile interface 100, the user may also view a market glimpse 140 which gives users a graphical display of trading in the DJAI, NASDAQ, S&P 500 and/or other markets or exchanges (including overseas markets, commodities exchanges, etc.) over a period of time.

FIG. 1a also demonstrates that a user may select to view other interfaces from the tabs 136 presented in the profile interface 100. For example, the user may select to view an interface dedicated to market information display (the “market” interface), or to the display of quote information (the “quote” interface) which are illustrated in FIGS. 1b and 1c, respectively. In one embodiment, when the user sets up an account or profile or via a function to edit personal settings (not shown), the user may select which tabs 136 to display when they log in, and may choose from among various available tools and functions for inclusion onto the interface associated with the selected tabs 136.

It is noted that in one embodiment, an RIA user, when “logging onto” the web-based module, may view an interface similar to the user profile interface 100 discussed in FIG. 1a; alternatively the user profile interface 100 presented to an RIA user may be specific to RIAs, and may include additional features such as co-trading compensation calculators and/or other client management tools.

It is also noted that other functionality including, inter alia, mechanisms for editing a profile, receiving help from an administrator or from a help file, and/or sending comments to an administrator may also be incorporated consistent with the present invention.

Referring now to FIG. 1b, an exemplary embodiment of the market interface 150 is illustrated. In one embodiment, the information contained therein is obtained by linking the user to a secondary information source (stock quote portal) such as that provided by inter alia, Quote Media, Scottrade, NASDAQ, etc. As shown in FIG. 1b, the exemplary market interface 150 displays to the user information from the Quote Media portal regarding various markets including, inter alia, information about the DJLA, NASDAQ and/or S&P 500. By selecting the appropriate tool on the toolbar 152, the user may view a market summary 154 which summarizes current market conditions, U.S. and Canadian indices (via the market indices tool 156), and/or world indices (via the world indices tool 160). The user may also select a market mover tool 158 to view information regarding volume activities, dollar and percent gainers and decliners in such markets as NYSE, AMEX, NASDAQ, OTCBB, OTO, TSX, and/or TSXV during market hours, pre-market hours, and post-market hours. The user is also presented with a currency tool 162 which when selected enables a user to view currency markets and convert currency.

Referring now to FIG. 1c, an exemplary embodiment of the quote interface 170 is given. As discussed above with respect to the quick quote tool 130, the information presented to the user may be obtained by linking to one or more stock quote portals. In the exemplary embodiment of FIG. 1c, quote information is retrieved and displayed from the Quote Media portal; however other portals may be utilized in conjunction with the present invention as well. At the quote interface 170, the user may select a tool from the tool bar 172 to view information regarding a user entered company. For example, a market tool 174 may be given which displays market update information similar to that information discussed above with respect to the market interface 150. A quote tool 176 may be given to display a detailed quote for the company; a Depth/Level I or II tool 178 may be given to display realtime “Level I or II” information; and/or an option tool 180 may be given to display option chain information (including composite, AOE, BOX, CBOE, ISE, PAO, PHO, and/or MOE) for “calls” and/or “puts”, at, in or out of the money.

Via a chart tool 182, the user is given options to view interactive and comparative charts; a news tool 184 gives recent news regarding the company and/or stock; a profile tool 186 displays profile information regarding the company. A financial tool 188 enables the user to view financial information (including, inter alia, balance sheets, cash flow and income statements) for a company; an insider's tool 190 displays information regarding insider activities. The user may also view SEC filings for the company and/or stock historical information over a user-selected period of time via a filing tool 192 and/or a history tool 194, respectively.

While aforementioned interfaces 100, 150, 170 are discussed in terms of one or more specific features, it is appreciated that a user may be given an option to display any number of different combinations of these features (including those discussed subsequently herein) as well.

Furthermore, the user may be given a tool (not shown) to instantly buy, sell or trade securities from any of the described interfaces 100, 150, 170, using either real money and investments (e.g., deposited funds), or “simulated” money and investments. Thus, a user may utilize the information received via the various tools, functions, options and interfaces 100, 150, 170 to make well-informed investment decisions, and also simulate actual trading before expending actual funds.

### Social Interfacing

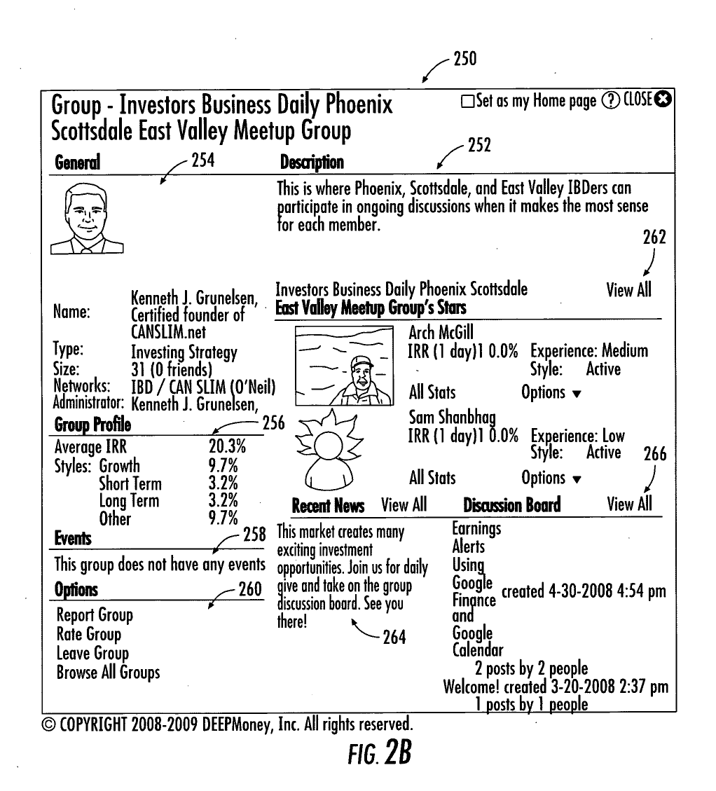

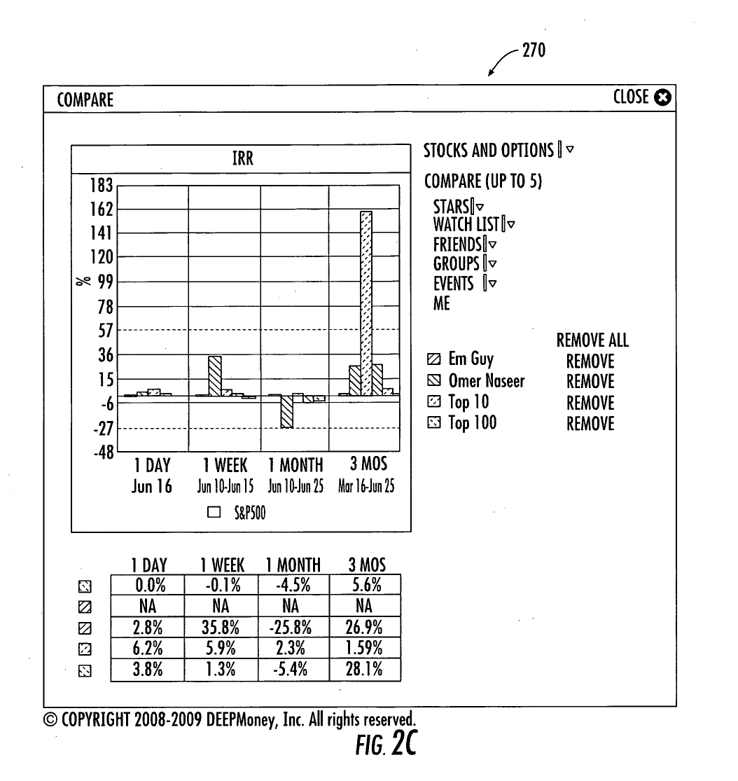

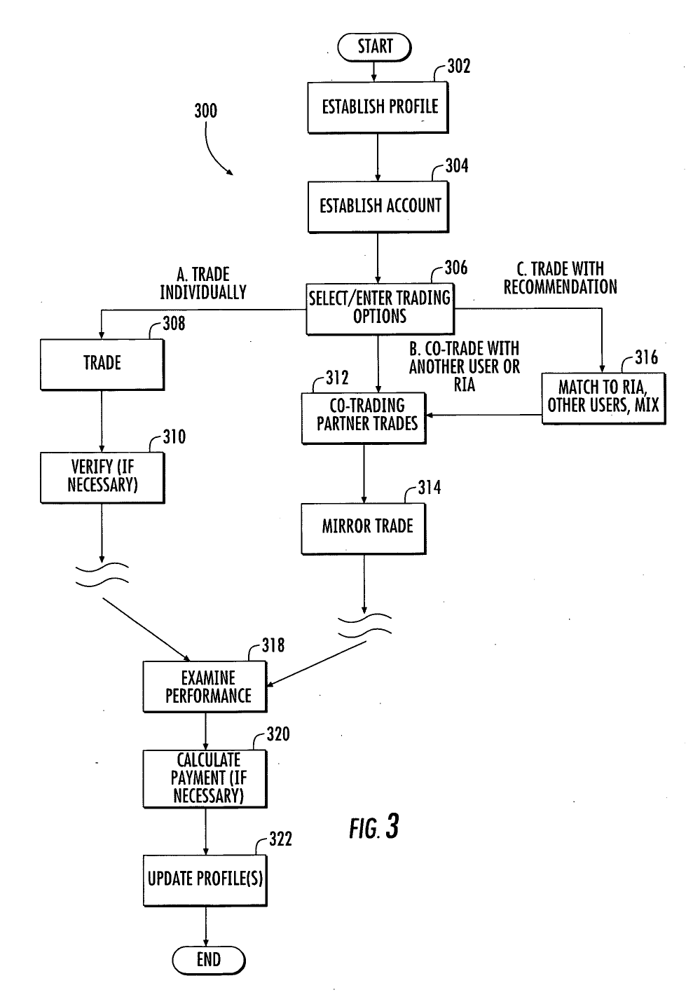

One aspect of the present invention is to provide a social network for users in which the users may search for and/or communicate with other users. Users are given tools for, inter alia, sending and receiving IM's (instant messages), such as individual chat and chat room features of the type well known in the electronic arts, sending and receiving e-mail messages, collecting and communicating among selected users as “friends”, and/or networking with users having common interests, investment goals, etc. Accordingly, in one embodiment, the interfaces represented by tabs 136 which the user may select among include a social interface. An exemplary social interface 200 is illustrated in FIG. 2.

In one embodiment, the social interface 200 may operate in a manner similar to FaceBook, MySpace, etc. which offer users unique social networking opportunities. Specifically, the social interface may enable users to form networks, form groups (e.g., trading clubs), compile events, keep a list (and display) of friends, chat with other users (via instant message, discussion boards, email messages, etc.), and so forth.

Exemplary network and group interfaces are given in FIGS. 2a and 2b respectively.

As illustrated in FIG. 2a, the network interface 230 displays to users a general description of the network 232 as well as a general information about the network 234 such as the type of investing and size of the network. The network profile 236 is also displayed. The network profile 236 gives the average IRR (individual rate of return) or ROI (rate of return), and growth, active, fundamental, and other styles. It is appreciated that other information may be optionally included herein as well. Network events 238 are listed at the network interface 230 to display to network members as well as new users when upcoming discussions, trading seminars, etc., whether conducted live or on the Internet, are scheduled.

A user is taken to the network interface 230 after showing some initial interest in its strategies, goals, members, etc. At the network interface 230, the user is presented with various options including an option to decline invitation to become a member of the network, delete the network from the user's list of personal networks, leave the network, and/or browse other networks.

The network interface 230 also gives users the opportunity to view top ranked investors belonging to that network 242, as well as discussion boards regarding topics of interest in the network 246 and groups within the network 244.

In FIG. 2b, an exemplary group interface 250 is given. The exemplary group interface 250 displays to users a general description of the group 252, as well as general information regarding the group's administrator 254. Any user can easily create a group and invite others. A group can be “open” (anyone can join and invite anyone else) or “closed” (only the administrator can extend invitations). Other access structures may be used as well, such as “open (limited)” (i.e., open to anyone, but with more restricted privileges or capabilities than the “open” designation), and so forth.

Also illustrated in FIG. 2b, the group interface 250 displays a visually threaded discussion board 266 and any number of events (real or virtual) 258 which can be associated with the group. Other features available to a user at a group interface 250 are listed on a tool bar 260 including the ability to report the group, rate the group, leave the group or browse all groups of the network. Rating the group is an option which the group administrator may enable, and which allows each member of the group to anonymously rate the group and provide feedback.

The group interface 250 also displays top ranked investors among the members of the group 262 (which may be ascertained according to any number of different criteria), and displays a profile of the group's earnings 256 (both long and short term) as well as their growth and average IRR. It is further appreciated that in one embodiment, a group and/or a network may produce income by charging subscription or one-time fees to members.

Referring again to FIG. 2, at the social interface 200, the user may search and sort through other users, in order to communicate with and/or view other users' investment strategies, histories, and portfolios. This includes the ability to communicate with and/or view investment strategy, history and portfolio of RIA professionals. The social interface also enables users to view a ranking of other user's investment abilities, co-trade with other investors, compare investors to one another, and communicate with other investors.

### Ranking

In yet another embodiment, when a user selects to view the social interface 200, all users (including investment professionals) are automatically sorted from highest to lowest dollar and/or percent profit gainers, and portions of the user profiles are displayed according to rank 202. The portions of the user profile include the user's profile photo 112, the user's name 113, as well as what networks 204 the user belongs to (networks will be discussed in greater detail below); the user's experience level 206 and style 208 are also displayed. Alternatively, a user may select an option to rank and view only RIA or only non-RIA users.

At the social interface 200, a user is also given a tool bar 210; the tool bar 210 enables the user to adjust certain aspects by which users are ranked. For example, the user may wish to view only top gainers from US markets only, or from only non-US markets, or from all markets. Additionally, the user may only wish to view top ranked gainers trading in actual securities rather than those trading in simulation (i.e., not actually trading), or may want to view both. The user may select among various market sectors (including e.g., financial services, energy, precious metals, semiconductors, etc.), and/or among only stocks or options or currencies, or futures traded (or alternatively among all securities traded). The user may also select the length of time over which the rankings are examined, for example, the user may only want to look at top gainers from the last day, week, month, or over more than one month or year. Other windows (which may start and stop at dates that are not the present date) may be specified as well.

When viewing one or more ranked profile of other users, a user may select among links which enable the user to: (i) view the selected user's portfolio (view portfolio link 212); (ii) view the selected user's blog (view blog link 214); and/or (iii) add the selected user to a group of users in order to watch or track progress (add to watch list link 216). The user may also select a set an alert link 218 to be notified with the selected user makes a trade either by message to the user interface 100, text message, or e-mail message.

### Co-Trading

Also illustrated in FIG. 2, the user may select a link to co-trade 220 with the selected user. Co-trading refers to the ability of a user to mirror (or substantially mirror) a selected user's trades. Such mirroring may be an exact replication of the co-traders activities (e.g., same number of shares in same proportions at generally the same times, etc.), or alternatively may follow one or more general frameworks of the co-trader (e.g., same proportions between equities, but different number of shares, some divergence in the equities traded, shifted timing of trades, etc.).

In one embodiment, when a first user selects to co-trade with a second user (co-trading partner), the user is informed of trades made by the co-trading partner so that the user may trade accordingly. The co-trading partner may be another individual user (non-RIA), or may be an RIA user. In another embodiment, when the user selects to co-trade with a co-trading partner, the co-trading partner's trades are automatically implemented by the user's account without the user's substantial intervention (at least to the dollar limit specified by the user).

In yet another embodiment, when a user selects to co-trade with a co-trading partner, the user's funds are transmitted to indirectly the co-trading partner for aggregation with those of other users prior to investing. Transmission of funds may be accomplished via Internet-based methods incorporating one or more escrow agents (such as PayPal, etc.), or may be facilitated by a third party trading server 404 from which the other functions described herein are accommodated. It is appreciated that a user who has been selected by another to become a co-trading partner may be at liberty to accept or deny the co-trading agreement, and/or may be compensated by the “mirroring” user(s) as a percentage of the mirroring amount or based only upon profitable trading as will be discussed below. Thus, lower-dollar-value investors (e.g., individual, non-RIA users in the aforementioned “90%”) are provided access to high quality managers with proven performance (either non-RIA users with a displayed profile, or RIA investors with significant expertise and experience).

### Comparing

A user may also use the compare tool 222 to select at least two ranked users and compare their progress. An exemplary comparison is given in FIG. 2c. As illustrated, the comparison tool 222 generates a graphical display 270 of the percent and/or dollar gains and losses of each selected user over one or more periods of time. In one embodiment, the user's progress is further graphically compared to one or more markets (such as S&P 500, NASDAQ, etc.).

### Communication

As discussed above, it is appreciated that the social interface 200 may, in one embodiment, be adapted to enable communication between users. Thus, links are provided to send messages to the selected user (send message link 226), add the selected user to the current user's friends list (add to friends link 116), and/or view the friends of the selected user (view friends link 224). Each of these functions is well known in the web interfacing arts and thus will not be discussed in greater detail herein.

A user also has the ability to communicate with users managing their finds in a co-trading situation. In this instance, communication between the parties may proceed via a manager/managee communication mechanism (not shown). Communicating via a different mechanism than the messaging 226 and/or friends 116 functions allows the managing user (RIA or other co-trading partner discussed above) to maintain anonymity from the users whose money they are investing, while still providing a secure and reliable mechanism for communication there between. In one embodiment, communications to a managing user regarding investment strategies, etc., are peer-reviewed by other users prior to sending such message to the manager. Sending messages in this way limits or eliminates unwanted, non sequitur, and/or unnecessary messages. In another embodiment, the managing investor may have the option to screen out communications from users based on one or more aspects such as e.g., amount of money invested, investment history, or type of investment.

Compensating Profitable Co-Trading Partners and/or RIA

As noted above in the instance where a user opts to co-trade with a second user (based on the published performance of the second user) or to co-trade with an RIA, the co-trading partner (second user or RIA), may be compensated by the user based on e.g., profitability and/or popularity. This is in contrast to prior art “straight” commission or fee schedules as previously described herein. For example, compensation to the co-trading partner may be based on the number of other users who opt to co-trade with that particular co-trading partner (popularity based), such that as more (or less) users trade with a given partner, the partner will receive additional compensation (which is non-linear with just the increased number of users); e.g., a total compensation of 5% if the co-trading partner is co-trading with 1-50 users, 7% for 51-100, 10% for 101-150, etc. In another embodiment, co-trading partners will be compensated based on a percentage of assets under the co-trading partners management (such as by amount of total monetary assets co-traded). In yet another embodiment, co-trading partners may set a percent or amount of compensation individually and/or a percent or amount of compensation may be determined by administrators of the synchronized securities trading system.

Alternatively, compensation to a co-trading partner may be based purely on performance; e.g., the percentage increase in the financial portfolio over a set period of time, irrespective of how many users use that partner. This may also incorporate one or more performance “thresholds”; e.g., co-trading partners/RLAs may not be compensated unless the user's investment profits above a predetermined threshold amount. The predetermined amount may be based on a standard index such as the S&P 500 or the DJIA, or may be a flat rate. For example, a user need only compensate a co-trading partner if the partner causes his investment to profit above the S&P 500, and/or to profit by 5% or more.

The foregoing criteria may also be combined, such as where the popularity-based scheme is also mixed with a based-based criterion (e.g., the graduated scale described above is only employed where the co-trader's performance exceeds a certain level).

Other alternative compensation schemes are readily appreciated by those of ordinary skill given the above disclosure.

### Methodology

As noted previously, the information (including information gained from viewing other user profiles, portfolios and investment strategies), features, and tools (including the co-trading tool) discussed above may be employed by the user to make investment decisions. Accordingly, a trading tool (not shown) is displayed at one or more of the abovementioned interfaces which transfers the user to a trading interface (not shown) from which the user may trade securities as an individual or elect to co-trade.

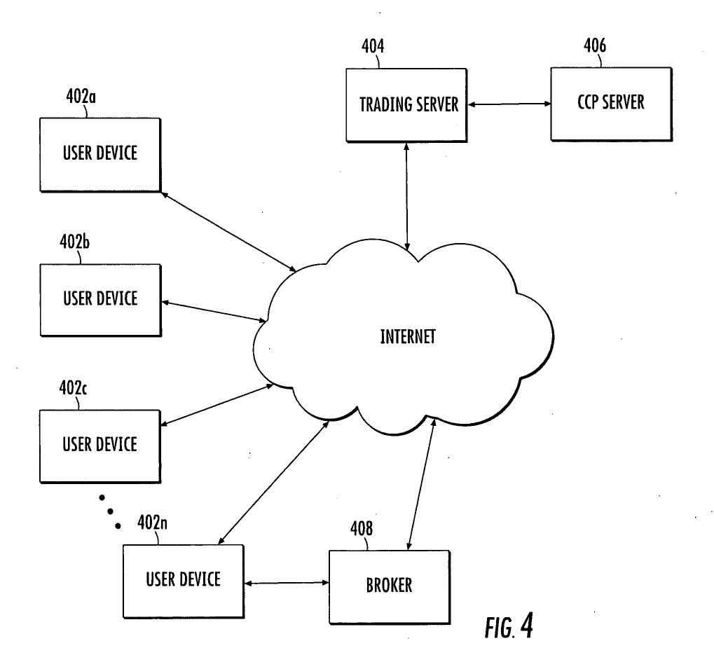

One exemplary embodiment of the method 300 for the trading of securities is given in FIG. 3. As illustrated, the method 300 comprises a user first establishing a profile (step 302). The establishment of a profile includes the user entering certain personal as well as administrative information. As noted above, the profile is used by a user to communicate with others as well as to access the functions, options and tools discussed above.

Next, per step 304, an account is optionally established with a custody and clearing partner (CCP). It will be appreciated that in the instance the user is making simulated trades, registration and account creation may be optional. The CCP is responsible for facilitating the user's trades In other words, the CCP processes trading requests for the users of the web-based module. The CCP is configured to connect one or more accounts and thus may manage co-trading functions with ease. However, it is noted that in another embodiment, an individual user may trade with a user-selected broker rather than a CCP. In order to establish an account, the user must give payment information, as well as other personal information such as a user id and password to protect the user's account from being misused. In one embodiment, the user establishes an account with the CCP (step 304) simultaneously with the establishment of a profile (step 302).

Next, at step 306, the user selects and/or enters one or more trading options. For example, the user may select and/or enter the type of security, amount of security to buy/sell/trade, amount of money to spend in a buying situation. It is also appreciated that the user may enter certain ranges or thresholds at which no trading is authorized, trading is triggered and/or alerts or reminders are sent. For example, the user may establish that he would like to continue holding IBM stock unless its value is below and/or above a certain amount. Alternatively, the user may select to be alerted when his entire portfolio loses a certain amount of money or gains a certain amount of money. This alert may comprise an instant message, email message and/or text message. The user may also select and/or enter to co-trade with a given co-trading partner, and place limits on the amount that can be co-traded.

If the user is trading individually (option A), i.e., is not co-trading, then, per step 308, the user may make one or more trades. As noted above, the trades may be serviced by a CCP, an RIA, or a user-selected broker/dealer; alternatively, the trades may be simulation trades wherein no money is exchange and thus the trades need not be serviced by any broker. If the user trades through a user-selected broker, subsequent to trading, the broker must verify and process the trades (step 310).

At step 318, after sufficient time has elapsed (such as one or more days, weeks, months, years), the user's performance is examined. For example, if examining daily, the trades made during that day are examined at the end of the day to analyze whether the user has profited or lost (calculated in percent or dollars gained or lost). Because the user traded individually (i.e., did not co-trade) there is no need to calculate payment to a co-trading partner per step 320. At step 322, the user's profile is updated according to the determined performance.

If the user is co-trading (option B) with either a second user or RIA co-trading partner, then per step 312, a trade is made by the co-trading partner. The trade is then mirrored, at step 314, by the user. Mirroring may occur automatically, or alternatively may be the result of one or more user confirmations or entries. In another embodiment (not shown), the user's funds are entangled with the co-trading partner's funds and thus are the trades are not “mirrored” per se but occur simultaneously.

After sufficient time has elapsed (such as one or more days, weeks, months, years), at step 318, the co-trading partner's performance is examined. As noted above, if the user's and/or co-trading partner's trades are serviced by an outside broker, the trades must be verified prior to the examination of performance. At step 320, if the co-trader has profited during the examined time period (e.g., beyond a prescribed level of performance), payment is calculated and secured. Then per step 322, the user and/or co-trading partner's profiles are updated according to the examined performance. Alternatively, if the co-trader has not profited during the examined period, the payment step 328 is bypassed and, per step 322 the profile(s) are updated.

In another embodiment, the user may select to trade with recommended strategies (option C), which will be discussed in greater detail below. Accordingly, the user's profile and investment goals will be utilize to match the user to one or more RIA, second users or a mixture of both RIA and second users (step 316). Then, when the co-trading partner(s) trade at step 312, their trades will be mirrored 314.

As above, after sufficient time as elapsed, at step 318, the co-trading partner's performance is examined; then if the co-trading partner was profitable per step 320, payment will be calculated and secured. Alternatively, the co-trading partner's payment may be computed as a percentage of the co-trade amount. At step 322 the profiles of the user and co-trading partner are updated.

### System Architecture

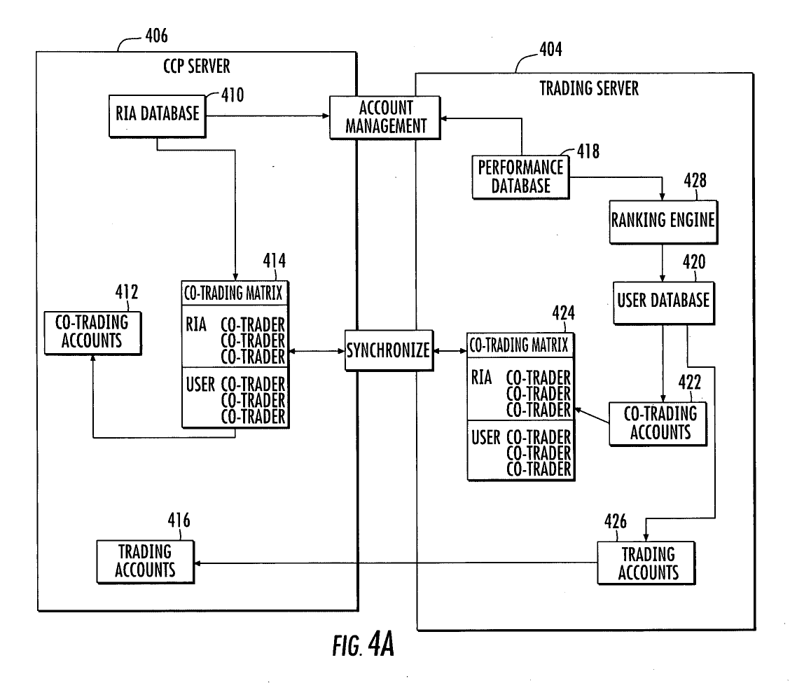

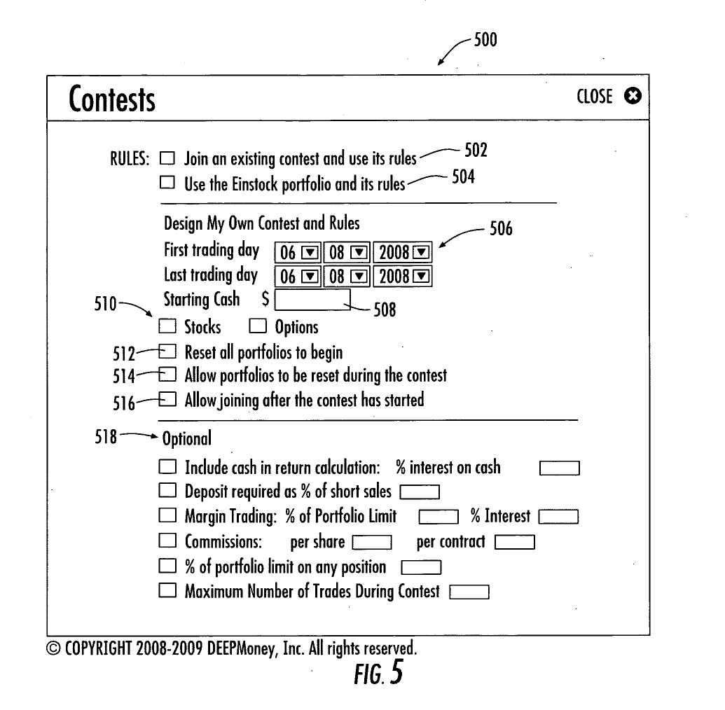

The above described methodology and functionality may be implemented in a network architecture such as that described in co-owned, co-pending U.S. Provisional Patent Application entitled “Method for Distributing and Using Investment Information” filed on Dec. 12, 2003 by inventor Sundby which is incorporated herein by reference in its entirety. Another exemplary architecture is illustrated in FIG. 4 herein.

As shown in FIG. 4, the user devices 402 each are adapted to comprise one or more computer programs which enable the devices 402 to connect to the Internet via well known mechanisms and protocols (e.g., TCP/IP transport). The user devices 402 generally comprise a computerized system having an interface with the Internet, one or more digital processor(s), a storage device, and a display mechanism (or connection thereto) for display of Internet content. The user devices 402 may comprise portable or non-portable, wired or wireless devices and are representative of the plurality of users (including RIA) who may access the web-based module to receive information, communicate and/or trade. Advantageously, the user interfaces described previously herein with respect to FIGS. 1A-2C can be scaled or constructed so as to work either on fully capable platforms such as desktop or laptop PCs, or alternatively “thinner” client devices such as 30 smartphones or PDAs, using well known software techniques. This advantageously allows the user to utilize common interfaces regardless of which platform they are using at any given time.

A trading server 404 is also shown in FIG. 4; the trading server 404 generally comprises storage device(s) and one or more digital processors. The digital processor of the trading server 404 may comprise one or more computer applications configured to produce the various interfaces 100, 150, 170, 200 and related functions, options and tools discussed above. Computer applications on the trading server 404 also facilitate communication among the various users 402a-402n such as by enabling, inter alia, instant messaging, email messaging, chat rooms, and message boards.

Applications on the trading server 404 also facilitate communication between one or more user devices 402 and a CCP server 406. The CCP server 406 is adapted to service user trades (i.e., conduct the actual exchange of consideration, etc.). The CCP server 406 also verifies trades made by users back to the trading server 404, in order for the verified trades to be incorporated into the user's profile. The CCP server 406 is adapted to comprise at least a mechanism for storing and updating co-trading matrices. The co-trading matrices enable the CCP server 406 to immediately perform mirroring trades. In other words, the CCP server 406 is configured to (prior to or just subsequent to servicing a co-trading partner's trade) also implement the same trade for the user(s) co-trading with that co-trading partner. As previously discussed, this mirroring may be effectively identical, or alternatively may simply bear a certain prescribed similarity or relationship to the co-trade (e.g., scaled down in size, same equities but different weighting, etc.).

In another embodiment, a user 402n may use a user-selected broker 408 (i.e., a broker of the user's choosing) which services trades and subsequently verifies trades to the trading server 404. Verification of trades may occur via an Internet connection (as shown), or through alternative mechanisms (e.g., telephone, facsimile, etc.).

It is also appreciated that the methods of the present invention may be practiced using any configuration or combination of hardware, firmware, or software, and may be disposed within one or any number of different physical or logical entities. Myriad different configurations for practicing the invention will be recognized by those of ordinary skill in the network arts provided the present disclosure.

Referring now to FIG. 4a, another exemplary embodiment of system architecture useful with the present invention is given. As illustrated, in this embodiment the CCP server 406 and trading server 404 work together to manage various user and RIA co-trading and individual trading accounts.

As illustrated, information regarding RIA history, portfolio and trades is stored at an RIA database 410 on the CCP server 406, this information is provided to the trading server 404 in order for the trading server 404 to perform risk adjusted performance analysis (for example using Morningstar or similar methodology) at a performance analysis engine 418 on the trading server 404. The information derived at the performance analysis engine 418 is used to update and/or compile the ranking of the various RIA, and other users via a ranking engine 428 on the trading server 404.

The trading server 404 further stores user information at a user database 420. When a user opts to trade individually (i.e., not co-trade), the user's information is stored in the trading server 404 trading accounts 426 and an entry into the CCP server 406 trading accounts 416 is also created and managed. Alternatively, when a user opts to co-trade, the user's information is stored in the trading server 404 co-trading accounts 422 and a trading server 404 co-trading matrix 424 is updated to include relevant information linking the user to a co-trading partner (whether an RIA or second user). The trading server 404 co-trading matrix 424 is then synchronized with a co-trading matrix 414 on the CCP server 406. The CCP server 406 is then able to derive, manage and store co-trading accounts 412 from the updated co-trading matrix 414.

Management of the trading 416 and co-trading 412 accounts by the CCP server 406 includes servicing the accounts (facilitating trades) and reporting the activity to the CCP server 404 in order to update the user profiles. The CCP server 406 will also update RIA database 410 with trading information.

It is noted that the embodiment of FIG. 4a is merely exemplary, and that one or more functions listed may be provided by alternative entities in communication with those entities shown. Moreover, one or more function of the trading server 404 and/or CCP server 406 may be performed on the alternate server (the CCP server 406 and/or trading server 404, respectively).

### Smart Index

As noted above, in one embodiment, the present invention provides users with an option to have their co-trading partner, investment decisions, etc. selected or recommended to them. In one variant, these recommendations are made utilizing an artificial intelligence (AI) engine (e.g., computer program) employing a “smart” index. The smart index comprises a personalized index which is based on an assessment of a particular user, such as by inter alia the user's financial goals, risk tolerance, tax bracket, available liquidity, geographic location, membership (or failure to qualify for membership) in certain classifications, demographics, etc. The assessment assists the AI engine in determining where the user's performance is not sufficient to reach the user's goals, etc. and generates suggestions for increasing performance while staying within the user's risk tolerance level. The AI engine may give suggestions in the form of recommending one or more RIAs, second users, or a mix of both RIA and second users for co-trading partnership. Then, as discussed above, the user may implement, via co-trading, the co-trading partner's strategies so as to ostensibly achieve their personal trading or investment goals. The AI engine may make real time investment suggestions which the user may implement on a non-co-trading basis. Alternatively, the AI engine may make co-trade decisions automatically for the user without additional user intervention.

### Alternate Embodiments and Features

In another embodiment, the present invention may be utilized to provide other features and/or options to a user. For example, the web-based module may be utilized to buy, sell, or trade services, newsletters, seminars, expertise, time and services of like value.

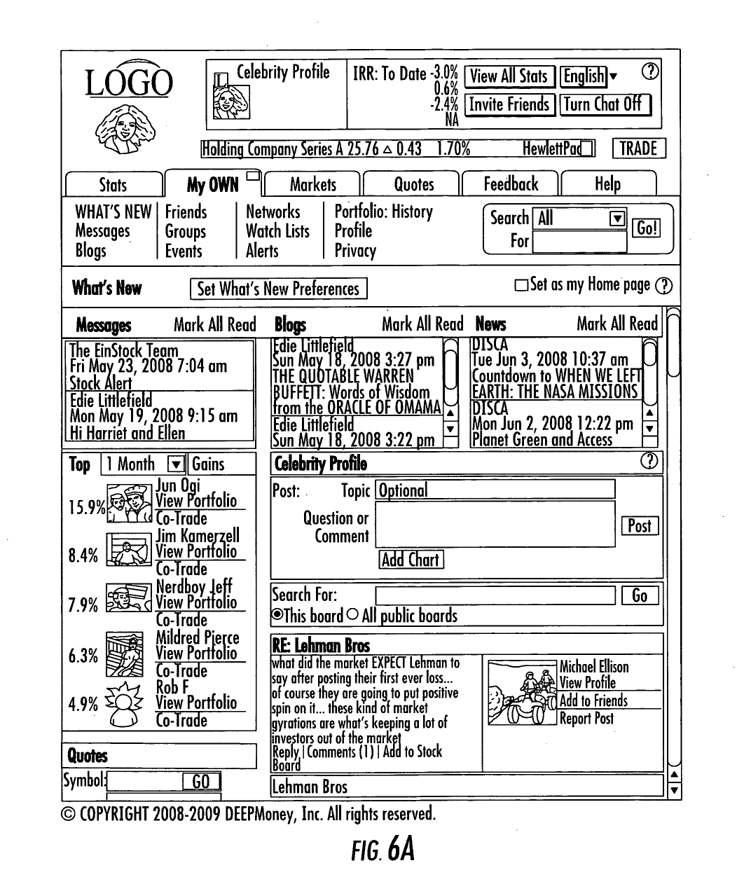

In yet another embodiment, the web-based module may be used for providing a “contest” engine. The contest engine is configured to support user-defined simulation challenges. An exemplary contest interface 500 is given in FIG. 5. As illustrated, at the contest interface 500, the users are able to join an existing contest and use its rules 502, or use the web-based module portfolio and rules 504.

The contest engine also enables users to create and manage contests (i.e., become a contest manager); thus, the contest feature may be used as an educational tool or promotional feature with sponsored prizes. Accordingly, the contest manager may establish the trading days 506 of the contest a well as how much simulation money each player will be given 508. At 510, the contest manager can establish what types of securities trades will occur. The contest player's previous portfolios may either be reset prior to beginning a contest 512 or may reset during the contest 514. Allowing a player to reset his portfolio prior to beginning a contest 512 enables a user whose existing portfolio does not conform to all of the parameters of a contest to reset the portfolio to the contest parameters. Allowing a player to reset during the contest 514 enables a player who is dissatisfied with the progress they have made in the contest to begin the contest over again (this feature may be enabled or disabled by the contest manager). Also, at 516, the contest interface 500 further enables a contest manager to allow or disallow users to join the contest after it has started. The contest manager can also select among various optional features 518 including whether to include cash in return calculation at a specified interest amount, whether to require deposits for short sales, what percentage of portfolio and/or interest will be permitted for margin trading; whether and how much commissions will be charged; a percent portfolio limit on any position, and/or the manager may set a maximum number of trades during the contest. Other optional features may be utilized consistent with the present invention as well.

### Funds and Portfolio Pooling

In another embodiment, contributing investors may be given an option to have their funds pooled (“pooled funds”) with those of other contributing investors, and invested by one or more selected managing investors or by a system that mirrors managing investor portfolios (such as the “STARpool” product discussed below). In other words, each user's (comparatively small) investment is aggregated to create a pooled fund. The pooled fund may then be distributed by the one or more selected managing investors across a range of investments having the desired level or profile of risk. Alternatively, the pooled fund may be distributed across several managing investor's portfolios. In another embodiment, the pooled fund may be distributed across pooled portfolios that mirror portfolios managed by managing investors.

The one or more managing investors may be selected on any number of different criteria, such as those having proven trading success. The selected managing investors may also be RIAs of the type previously described herein. Alternatively, the selected managing investors may not be individual people, but instead a group of investors (such as those belonging to a single investment advisory firm (IAF), or alternatively an unrelated group), and/or a substantially computerized entity (such as a computer program adapted to make trades based on a prescribed set of investment objectives).

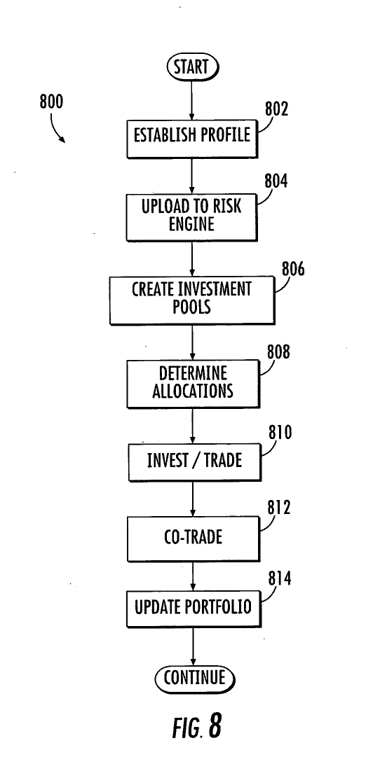

In order to ensure quality of service among the managing investors of an IAF, the IAF may be required to submit certain information confirming good practices. For example, the IAF may be required to provide audited statements demonstrating that their accounting records conform to Global Investment Performance Standards (GIPS) or other performance standards (e.g., FASB). In another embodiment, the IAF may be required to demonstrate that they provide custody for assets and clear transactions through reputable providers. In one embodiment, the IAF must produce independently audited confirmation or the custody firm must provide the data (they are the independent verifier). An exemplary architecture 700 for providing pooled investments according to the present invention is illustrated in FIG. 7. As shown, the architecture 700 generally comprises a plurality of contributing investor devices 703 and a plurality of managing investor devices 702. The managing investor devices 702 and contributing investor devices 703 may, in many instances comprise devices of the type similar to the user devices 402 discussed above, the managing investor devices 702 simply being operated by a selected managing investor or group of managing investors and the contributing investor devices 703 being operated by investors contributing to a pooled account (as will be discussed below).

The contributing investor devices 703 and managing investor devices 702 of the embodiment of FIG. 7 are in communication with a plurality of entities of a securities trading system 704. The securities trading system 704 comprises, inter alia, a trading server 404 in communication with a CCP server 406. As discussed above, the trading server 404 facilitates securities trades via a CCP server 406.

The securities trading system 704 further comprises an investment management entity 706, and a storage entity 708. As discussed above, user profiles are created via e.g., a web interface. The profiles may then be transmitted and securely stored at the storage entity 708. In one embodiment, a managing investor's profile may further include information relating to the managing investor's portfolio which will be used, as discussed below to make a risk-adjusted determination of performance. In another embodiment, managing investors may have their portfolio uploaded from a custody provider (e.g., Pershing, Schwab, etc.) platform or data base. It is appreciated the managing investor's portfolio and other data may be anonymized and/or securely transferred. In yet another embodiment a managing investor's profile data may be entered manually by the managing investor himself.

As illustrated in FIG. 7a, the investment management entity 706 generally comprises a plurality of interfaces 710 (e.g., IEEE-1394 “Firewire”, USB, WiFi, WiMAX, etc.) for communicating with the other entities of the securities trading system 704 as well as with the contributing investor devices 703 and the managing investor devices 702 via the Internet. The management entity 706 further comprises a processor 712 and associated random access memory (RAM) 718. In the illustrated embodiment, the processor is adapted to run at least a computer program for tracking 714 and a risk management engine 716 thereon.

The computer program for tracking 714 is, in one embodiment, adapted to maintain records relating to the activities of individual ones of the contributing investors and/or managing investors. In one embodiment, the tracking program 714 may be adapted to maintain records regarding only the managing investors' activities with respect to a pooled trading account (discussed below). Alternatively, the tracking program 714 may maintain records regarding all activities of all of the users (both managing and contributing investors). The records collected by the tracking program 714 may be updated daily, weekly, etc. or may be updated at each instance of a trade or exchange made by the managing and/or contributing investor.

The tracking program 714 monitors the records for unexpected deviations such as unexpectedly high or low returns, changes in the way a managing investor normally invests, or other factors which may have an effect on the categorized risk of a managing investor's portfolio or risk suitability of a contributing investor to continue to invest in a specific pooled account. The historical analysis of both contributing and managing investors' risk-adjusted performance may be compared to current performance indicators to determine such unexpected deviations, etc.

Monitoring a managing investor by the tracking program 714 may also cause the profiles of contributing investors (i.e., those investors who have contributed to a pooled fund managed by the managing investor) to be automatically updated in a manner similar to that discussed above with respect to co-trading. For example, suppose Managing Investor A makes a trade with pooled funds and Contributing Investor B has contributed to (i.e., entered) the pool managed by Investor A. Then, the trade by Investor A will be monitored and records of the trade are made available to Investor B. The monitoring function of the tracking program 714 her causes the profile of Investor B to be updated to reflect Investor A's trade with pooled funds.

The tracking program 714 may be further adapted to make recommendations to an administrator (not shown) and/or to the contributing investor regarding the suitability of the managing investor as a manager of the pooled funds. In this way, the system is adapted to notify contributing investors and/or a system administrator when or if the managing investor's performance slips or if the managing investor's risk level is not similar to historical risk levels. For example, the tracking program 714 may collect information regarding trading among all investors (managing investors and individual investors whether or not contributing to a pooled account) and use this information to identify one or more of these persons showing high success rates (while still maintaining user anonymity). The highly successful investors may be invited to become managing investors with respect to upcoming pooling opportunities (i.e., when a new pool has been formed). In another embodiment, the program 714 may use the information collected to identify investors showing low success rates. If the low-success investors are currently managing investors, this information, as noted above, may be used to notify an administrator or the contributing investors. If the low-success investor is a contributing investor or a general investor neither managing nor contributing to pooled accounts, the information may be used to target the investor for recommendations, such as co-trading options, additional services, etc.

The risk management program 716 is, in one embodiment, adapted to utilize information received from the tracking program 714 as well as information in a managing investor's profile and/or portfolio (received from the storage entity 708) to analyze the managing investor's performance. A managing investor's performance may be analyzed over a period of time, such as daily, weekly, monthly, etc. The risk management program 716 may be further adapted to generate one or more performance metrics, such as those measured and utilized by e.g., the RiskMetrics Group™.

Thus, in one embodiment, the risk and return of a managing investor's portfolio is compared over time to determine a risk-yield analysis. The risk-yield analysis may be made over each of the managing investor's individual portfolios, thereby enabling the risk management program 716 to determine which ones of the investor's portfolios have proven most successful.

The risk engine 716 analysis may, in one embodiment, be provided back to the managing investors as interactive graphs, data and firm comparisons.

The portfolio and tracking information is then adjusted based on one or more risk factors which categorize the managing investor's portfolio performance by risk category. For example, the most successful ones of a managing investor's portfolio (as determined by the risk engine 716) may be classified as being generally high risk, generally low risk, etc.

In another embodiment, most successful ones of the managing investor's profile are placed into predetermined risk-yield categories. For example, portfolios within a certain risk-yield range are grouped together into a pooled portfolio category. Each of the portfolios in the category represent portfolios of different managing investors each have a similar risk-yield factor. As will be discussed in greater detail below, the contributing investors may select one or more of these risk-yield categories for investment.

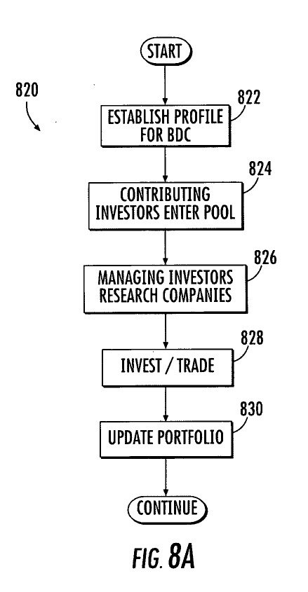

Referring now to FIG. 8, an exemplary method 800 of portfolio pooling is illustrated. As shown, per step 802 managing investors establish profiles at a web interface such as that discussed above with respect to FIGS. 1-1c. The managing investor's profiles may include anonymized portfolio data which has been uploaded from their accounting system or custody platform provider. In another embodiment, the managing investors may manually enter portfolio data. The portfolio and profile data are stored at the storage entity 708.

At step 804, the portfolio data is uploaded from the storage entity 708 to the risk engine 716 of the investment management entity 706. The risk engine 716 analyzes risk and yield data to determine one or more risk-adjusted performance indicators. The risk engine 716 may further categorize each of the managing investor's portfolios into a risk category. For example, certain ones of the managing investor's portfolios may be categorized as high risk investments, while others are considered low risk.

Additionally independent verification of money management is provided such that the present invention provides analysis and monitoring of managing investors. For example, each managing investor's individual portfolios are analyzed independently to determine an actual historical performance of each portfolio. As discussed above, this information may be simultaneously provided to the managing investor himself for self-initiated tracking purposes.

At step 806, various investment pools are created. In one embodiment, the aforementioned analysis is utilized to select certain ones of the managing investor's portfolios which have a proven rate of success. If the managing investor agrees to have the selected portfolios utilized he may also determine a maximum amount of contributing investments (a dollar or equivalent threshold).

The selected portfolios are assigned a risk category, thus, the contributing investors may then enter into a pool based on the investor's risk tolerance. For example, a contributing investor may seek to join a pool of portfolio having relatively low risk. The contributing investor may join any number of portfolio pools, thus distributing his/her investment dollars across a number of risk categories.

It is further appreciated that investment pools may be created based on the security traded. For example, certain commodities have generally low risk, such as treasury investments. Contributing investors who desire to invest solely and specifically in treasury investments may enter a treasury pool. For example, in one embodiment the treasury pool may comprise the Tpool product offered by the Assignee hereof. Securities trading in venture capital investments is generally considered high risk. Contributing investors who desire to invest solely in venture capital investments may enter a venture capital pool, which, in one embodiment may comprise the VCpool product offered by the Assignee hereof). However, certain contributing investors may desire pools which are less specific to a certain type of investment. For example, a high risk pool may be established for generally high risk investments. A high risk pool may include investments in venture capital investments, but are not limited thereto. Further, low risk pools may be established for investments which are generally low risk, including, but not limited to, treasury investments.

In yet another embodiment, contributing investors may enter a pool for medium risk investments such as corporate bonds, U.S. and international equities, etc. In one embodiment, a medium risk pool may comprise the STARpool product offered by the Assignee hereof. As will be discussed in greater detail below, in a further embodiment, contributing investors may enter pools dedicated to investments in environmentally friendly (so called “green”) technologies, companies, etc.

In another embodiment, a single pool may be used to provide investment opportunities for contributing investors across more than one category of investment. For instance, the pool may enable contributing investor's pooled funds to be distributed among treasury investments and venture capital investments, etc. In other words, a contributing investor enters a diverse pool, the pooled funds of the diverse pool are then invested in high, medium and low risk investments. In this way, large investments tooled funds) may be spread across a range of portfolios with comparable risk.

In another embodiment, a contributing investor may invest in high and low risk investments separately; in other words, a certain percentages of the contributing investor's total funds may be allocated among the high and low risk investments (e.g., 80/20, 70/30, etc.). For example, the contributing investor may invest in a Tpool as well as either a VCpool or GREENpool (discussed below). In yet another embodiment, the contributing investor may additionally invest in a pool which mirrors one or more managing investor portfolios (such as the STARpool product discussed above).

The desired allocations among the various investments may be determined by the contributing investor investing in different mutual funds (e.g. $8,000 in a Tpools mutual fund and a separate $2,000 in VCpools mutual fund). In another embodiment, the desired allocation may be accomplished by the contributing investor investing in a “separately managed account” (SMA) that already includes the desired allocations (such as an SMA which utilizes $10,000 in an 80/20 percent split among Tpools and VCpools). Still further, the contributing investor may invest in a mutual or exchange traded fund (ETF) that accomplishes the desired allocation (such as the aforementioned utilization of $10,000 in an 80/20 percent split among Tpools and VC pools). However, the ETF is traded on an exchange thus is associated with a much lower cost and minimum; and further the contributing investor may buy as little as one share (as opposed to $10,000 or more to open an SMA.) It is further appreciated that alternative vehicles may be utilized consistent with the present invention as well, including e.g., Fund of Funds (FOF), business development companies (BDC) and/or unified managed accounts (UMA) for affecting the aforementioned investments. It is appreciated that any combination of the above described pools and/or allocations among the pools may be utilized consistent with the present invention.

A particular portfolio in a pooled portfolio may, in one embodiment, have a target investment amount. In other words, that portion of the pooled portfolio remains open until enough contributing investors have entered so that the funds of each contributing investor when pooled, reach the investment target. In one embodiment, as noted above, the investment target is determined based at least in part on a maximum investment threshold the managing investors are willing to have mirror their portfolio. In other words, the managing investor may continue to trade securities in the portfolio which has been made a part of the portfolio pool; in this case, it may not be prudent in some circumstances for too much additional investment. Hence, using a maximum investment threshold scheme the managing investor may continue to trade on the portfolio without affecting his/her client's interests. Alternatively, a time-based criteria for the formation of a pool may be used.

Next, per step 808, an allocation of the pooled funds (funds from all of the contributing investors) is determined. In other words, it is determined what percentage of the entire investment will be distributed to each of the individual profiles of a risk category and/or investments of an investment based-category (such as the aforementioned low risk pools, treasury pools, etc., and/or any combinations of the above). The allocations may be made by mathematical formula, by an authorized manager, by the contributing investor, or any combination of these entities.

The pooled funds may be invested as a single IAF-created account (funded by the pooled money). In another embodiment, the contributing investor's money may be pooled into a mutual fund to be allocated among several IAF accounts or other managing investors having portfolio in the pool. In yet another embodiment, an ETF may be created for each risk category. Alternatively, the contributing investors may be given access to the various pools via a BDC, SMA and/or UMA.

At step 810, the managing investors trade on their portfolio. These trades are then mirrored (e.g., co-traded as described above) by the pooled finds (step 812).

Once the pooled funds are invested (step 812), the profiles of the managing investor(s) and contributing investors (pool members) are updated at step 814 to reflect the investment(s). In one embodiment, the update may simply reflect that the managing and/or contributing investor has invested in a treasury pool, venture capital pool, etc. Alternatively, the profile may reflect each individual investment of the pooled finds.

The user profile may be continuously updated (step 814), such as daily, weekly, etc. to reflect market-related changes of the managing and/or contributing investor's investments.

### Pooling in Companies Developing Climate Friendly Products, Services, and Technologies

In another embodiment, users may enter pools for investing in environmentally responsible “green” companies (hereinafter referred to as “green pools”). In one variant, the green pools may comprise the GREENpool product offered by the Assignee hereof. The green companies may include companies which focus on green energy, automotive, airline travel, household products, etc. The green companies may be established companies and/or new, start-up companies.

In one variant, the managing investor(s) may only invest in green companies which trusted venture capital firms are or have invested in.

Investments into the green companies may, in one embodiment, be effected via a publically traded private equity vehicle or business development company (BDC). According to this embodiment, the green pool finds a BDC which invests in green companies.

Referring now to FIG. 8a, an exemplary method 820 of establishing and maintaining a green pool is given. At step 822, a profile is created for the BDC. The profile establishes that the BDC is primarily interested in “green” investments. The BDC is a “direct” investment vehicle in companies themselves (instead of through other investment funds). As note previously, investment may also be affected through e.g., an FOF, ETF, SMA and/or UMA. The profile may also list a risk category (as discussed above) generated by a risk engine 716.

Next, per step 824, contributing investors who desire to invest in green companies join the green pool. As with the other pools discussed above, the green pool may have a target finding amount and/or may be held open for a predetermined time in order to allow contributing investors to enter the pool.

At step 826, one or more environmentally responsible companies are researched and selected by a one or more managing investors associated with the BDC. The managing investors examine the products or services offered by the company, financial aspects, and other indicators of the company's potential for success. The managing investors further examine environment-related aspects of the companies in order to access whether in fact the company is “green” and the potential for viability (from an environmental standpoint) and importance of the “green” company's technology in order to select one or more for investment.

Next, per step 828, the BDC uses the green pool funds to invest in the selected companies, and at step 830, the user profile (for the BDC, managing investors, and/or contributing investors) are updated.

### Other Pools

It wilt be appreciated that the foregoing pools are merely exemplary in nature and that other pools may be formed consistent with the present invention. For example, pools may be formed by contributing investors who wish to invest according to a common investment interest or goal. Pools may also be formed by contributing investors who are related, that is, contributing investors who share some common trait, or are co-workers, family members, or friends.

The managing investor for the aforementioned pools may be determined as above based on an establish record of investment success. Alternatively, the contributing investors may elect a managing investor (whether a pool member or not) to direct investments. In another embodiment, the contributing investors of the pool may make group decisions with respect to investment strategies.

### Business Methods

Various business models are useful given the present disclosure.

In one embodiment, the aforementioned web-based module may be utilized to give and receive monetary gifts for investment to/from other users. Accordingly, a user may select to give money from directly from the user's portfolio earnings, or may use one or more alternative payment methods. The gift may be temporarily linked to a guest account, which the gift receiver will be able to access, personalize and begin using. Alternatively, the gift may be transferred to the gift receivers previously established account in generally similar manner as prior art Internet-based gift cards are bought, given, and used.

In another embodiment, a user may elect to trade as an individual directly from one or more of the web-based module interfaces. Accordingly, a business model may be given for referring the user to one of a plurality of brokers. The broker may be selected for referral based on a number of factors including agreement to verify securities trades made by the user to the trading server 404 as discussed above.

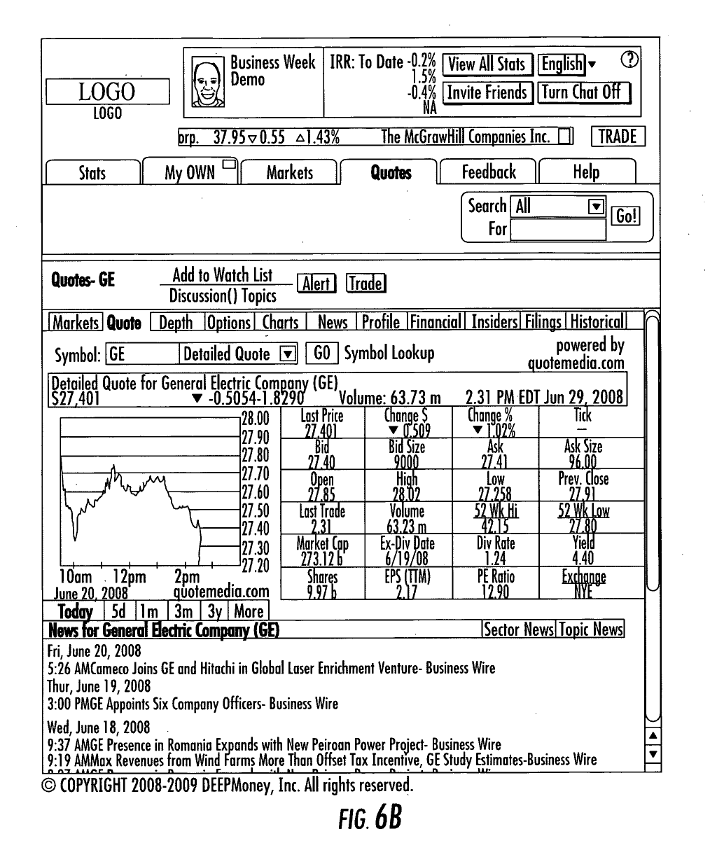

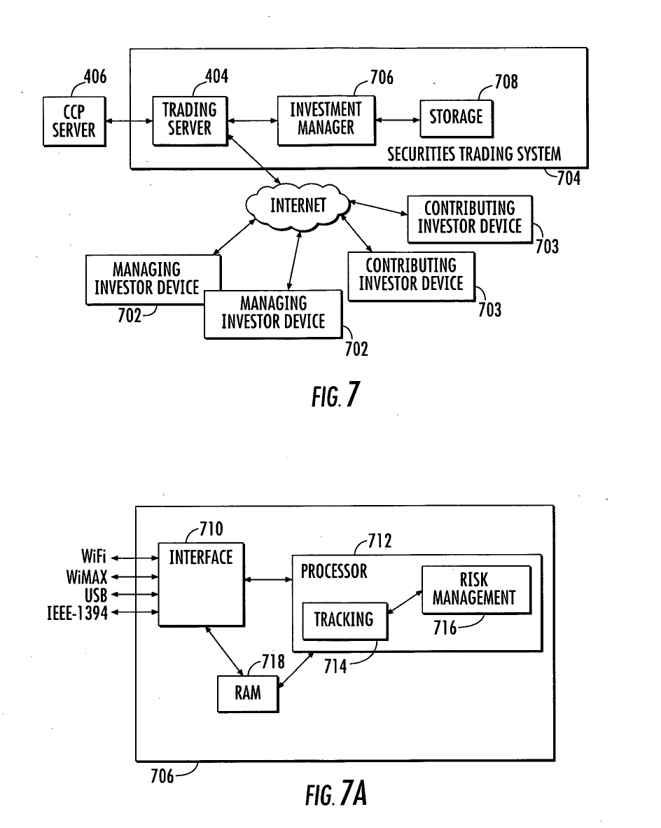

In yet another embodiment, access to at least some functions of the web-based module is given to users without cost because various advertising methods are employed in conjunction with the described invention. For example, the previously described functions may be presented inside an iFrame, which can be embedded in any web page (e.g., HTML or XML rendering) with a single command. Thus, one or more of the tools and interfaces discussed above may be deployed in financial portals, lifestyle and money websites such as Business Week Investing Community, Yahoo Finance, MSN Money, American Association of Individual Investors, etc. as well as in other traditionally more social networks such as MySpace, FaceBook, etc. Exemplary embodiments of the iFrame discussed above inserted into Oprah Winfrey Network and Business Week Investing Community websites are given in FIGS. 6a and 6b, respectively.

In another embodiment, a portion of the user interface 100 may be a standard advertisement size so as to enable insertion of targeted and/or rotating ads at each page change. In yet another embodiment, rather than offering an iFrame, the web-based module may be incorporated into smaller widgets having specific function, for placement onto the previously mentioned financial, lifestyle, money, and social networking websites.

It is noted that many variations of the methods described above may be utilized consistent with the present invention. Specifically, certain steps are optional and may be performed or deleted as desired. Similarly, other steps (such as additional eligibility screening, credit analysis, etc.) may be added to the foregoing embodiments. Additionally, the order of performance of certain steps may be permuted, or performed in parallel (or series) if desired. Hence, the foregoing embodiments are merely illustrative of the broader methods of the invention disclosed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method of providing to a user synchronized trading of securities, said method comprising:
providing a list of trading entities and information relating to the performance thereof;
selecting at least one of said plurality of trading entities from said list;
servicing at least one trade of securities by said trading entity;
servicing at least one similar trade of securities by said user;
examining the performance of said trading entity based at least in part on said serviced at least one trade of securities by said trading entity; and
calculating payment to said at least one trading entity based at least in part on said examined performance.
